(19) United States
(12) Patent Application Publication
(10) Pub. No.: US 2011/0208900 A1
(43) Pub. Date: Aug. 25, 2011

(54) METHODS AND SYSTEMS UTILIZING NONVOLATILE MEMORY IN A COMPUTER SYSTEM MAIN MEMORY

(75) Inventors: Franz Michael Schuette, Colorado Springs, CO (US); Lutz Filor, San Jose, CA (US)

(73) Assignee: OCZ TECHNOLOGY GROUP, INC., San Jose, CA (US)

(21) Appl. No.: 13/032,805

(22) Filed: Feb. 23, 2011

Related U.S. Application Data
(60) Provisional application No. 61/307,023, filed on Feb. 23, 2010.

(51) Int. Cl. G06F 12/00

(52) U.S. Cl. 711/103; 711/E12.008; 711/E12.083

(57) ABSTRACT

Methods and systems capable of capitalizing on fast access capabilities (low initial access latencies) of nonvolatile memory technologies for use in a host system, such as computers and other processing apparatuses. The host system has a central processing unit, processor cache, and a system main memory. The system main memory includes first and second memory slots, a volatile memory subsystem having at least one DRAM-based memory module received in the first memory slot and addressed by the central processing unit, and a nonvolatile memory subsystem having at least a first nonvolatile-based memory module in the second memory slot and addressed by the central processing unit. At least one memory controller is integrated onto the central processing unit for controlling the processor cache, the volatile memory subsystem, and the nonvolatile memory subsystem.

### CROSS REFERENCE TO RELATED APPLICATIONS

This application claims the benefit of U.S. Provisional Application No. 61/307,023, filed Feb. 23, 2010, the contents of which are incorporated herein by reference.

### BACKGROUND OF THE INVENTION

The present invention generally relates to memory devices for use with host systems, including computers and other processing apparatuses. More particularly, this invention relates to a host system having a system main memory comprising nonvolatile (permanent) memory-based devices that are directly accessed through a memory controller integrated onto a central processing unit of the host system.

Nonvolatile memory subsystems of modern computers are typically addressed through the system bus using the southbridge or any equivalent logic, for example, the I/O controller hub (IHC) introduced by Intel Corporation. The most common form is the advanced technology attachment (ATA) in its various iterations, with hard disk drives (HDDs) or solid-state drives (SSDs) serving as the nonvolatile mass storage media. Alternatively the universal serial bus (USB) in its second and third generation provides attractive alternatives, especially for removable media. In all cases, however, the data need to make several steps through the system logic before they are written to or read from the main memory (volatile memory) of a computer system to its nonvolatile memory subsystem.

From a functional overview of the different levels of memory from processor cache to nonvolatile mass storage, the most efficient approach would use the shortest pathways with the lowest latencies from one level to the next. In past architectures, this was not always the case. For example, processors had a Level 1 cache on-die, a Level-2 cache on the motherboard that was controlled by a separate cache bus, the system main (volatile) memory located on the motherboard using memory (expansion) slots (sockets) and addressed through the northbridge as part of the chipset (or system logic), and finally one or more hard disk drives remotely mounted in the system's chassis and interfaced through the southbridge using cables. FIG. 1 is representative of such a memory architecture, in which the system main memory is made up of volatile memory devices, for example, DDR (DDR-SDRAM; double data rate (DDR) synchronous dynamic random-access memory (DRAM)) modules, that are accessed by the CPU through a memory controller (not shown) integrated into the northbridge.

The current state of personal computer technology has consolidated most of the different levels, at least to the degree where all controllers are integrated on the processor package or even die. In more detail, the central processing unit (CPU, or central processor) now features all cache levels on-die, and the system main memory is interfaced by a memory controller integrated onto the CPU. FIG. 2 is representative of this memory architecture, in which the main memory is still made up of volatile memory devices, but is directly connected to the CPU as a result of the memory controller being integrated onto the CPU. The fact that the main memory is still on the motherboard is dictated by design constraints and economic considerations, for example, configuration flexibility and expandability. Functionally, however, in this configuration the main memory of the computer is governed by the CPU rather than a secondary system logic.

In the case of nonvolatile storage, inherent latencies of hard disk drives such as rotational and seek latencies are prohibitive for the system to take advantage of low latency access paths. Based on long initial access times, similar reasons apply in the case of NAND flash-based solid-state drives. Given these delays, there has been no incentive for trying to integrate the control of nonvolatile mass storage devices on the level of the CPU.

NAND flash technology is rapidly approaching the end of its scalability towards smaller process nodes because proximity effects such as read and write disturbances become progressively worse with smaller process geometries. Consequently one can expect a shift towards alternative storage technologies, such as ferromagnetic RAM (FRAM), magnetic RAM (MRAM), resistive RAM (RRAM) or phase change memory (PCM) to occur in the near future. PCM, RRAM or even NOR flash devices such as Spansion's MirrorBit® NOR flash have substantially shorter initial access latencies and, more importantly, the endurance of these devices is higher than what is seen in NAND flash memory. Given the different characteristics of the above-mentioned devices, it appears necessary to reconsider the strategies of approaching nonvolatile storage of data in the next generations of computer systems, in particular since the average daily data load is in no relation to the overall device capacity of current storage media capacities of terabytes and beyond.

One way of coping with the different demands on the storage subsystem of the entire computer memory space is to create different levels or tiers. In that case, the classic hard disk drive may become an archival media, serving primarily for storage of digital entertainment such as movies or other audiovisual contents and large files, for example, medical image databases. The next tier could be a NAND flash based solid-state drive with all the advantages and drawbacks of NAND flash technology and a system bus using ATA technology to interface with the device. Alternatively, as represented in FIGS. 1 and 2, a flash cache module (FCM) card (for example, the Turbo Memory technology introduced by Intel Corporation) enables flash memory devices to be plugged directly into a compatible socket through the southbridge as an extension of the PCIe bus.

As mentioned earlier, in view of the relatively high initial access latencies of NAND flash, chipset latencies associated with the Turbo Memory technology are essentially negligible. Moreover, in view of NAND flash reaching true commodity pricing, the capacity of these storage devices, regardless of actual implementation, will increase to terabyte (TB) values. It is, therefore, conceivable that NAND flash-based storage devices will become the primary workhorse for day-to-day operations of compute memory storage systems since even smaller drives will offer capacity in excess of the footprint required for operating systems and applications.

The last tier outside a CPU's cache levels is the system main memory which, as noted above, typically consists entirely of volatile memory devices, typically one generation or another of DRAM devices. The current form of main memory is limited by a number of parameters including refresh overhead, which becomes increasingly prohibitive for performance and also for the power budget. In addition, cost per bit is still roughly 10× of that of nonvolatile memory solutions, even when taking emerging technologies into consideration. At the same time, new nonvolatile memory species are moving towards very low access latencies that would be wasted in architectures going through several hardware hops and potential protocol translations, not to mention arbitration across a shared bus.

### BRIEF DESCRIPTION OF THE INVENTION

The present invention provides methods and systems capable of capitalizing on fast access capabilities (low initial access latencies) of nonvolatile memory technologies currently available for use in host systems, such as computers and other processing apparatuses.

According to a first aspect of the invention, a host system is provided having a central processing unit, processor cache, and a system main memory. The system main memory comprising first and second memory slots, a volatile memory subsystem comprising at least one DRAM-based memory module received in the first memory slot and addressed by the central processing unit, and a nonvolatile memory subsystem comprising at least a first nonvolatile-based memory module in the second memory slot and addressed by the central processing unit. At least one memory controller is integrated onto the central processing unit for controlling the processor cache, the volatile memory subsystem, and the nonvolatile memory subsystem.

According to a second aspect of the invention, a method is provided for expanding a system memory space of a host system that comprises a motherboard, a central processing unit having an integrated processor cache, a system logic, a nonvolatile memory-based mass storage device controlled by the system logic, and at least two memory slots. The method includes installing a DRAM-based volatile memory module and a first nonvolatile-based memory module in the memory slots, directly controlling the DRAM-based volatile memory module and the first nonvolatile-based memory module with at least one memory controller integrated on the central processing unit, and using parallel command address and data buses as an interface between the first nonvolatile-based memory module and the central processing unit.

According to another aspect of the invention, a method is provided for creating a high-capacity system main memory in a host system, in which a central processing unit comprises an integrated cache and an integrated memory controller that accesses the system main memory. The method comprises installing a nonvolatile-based memory device in the system main memory and operating the integrated memory controller to write and read data to and from the nonvolatile-based memory device.

In view of the above, the present invention can be seen to utilize a system main memory that includes a nonvolatile memory subsystem comprising nonvolatile (permanent) memory devices, in combination with one or more memory controllers that can be integrated onto a CPU of a host system. In certain embodiments, the memory controller can treat the nonvolatile memory subsystem as a physical extension of a system main memory that otherwise conventionally comprises volatile memory devices.

Other aspects and advantages of this invention will be better appreciated from the following detailed description.

### BRIEF DESCRIPTION OF THE DRAWINGS

FIG. 1 schematically represents a conventional memory system architecture of a host system that comprises a system main (volatile) memory connected to a northbridge of a chipset, and other devices of the host system, including nonvolatile memory devices such as P-ATA and S-ATA drives, connected to a southbridge of the chipset.

FIG. 2 schematically represents another conventional memory system architecture of a host system, in which a memory controller is integrated onto a CPU and a system main (volatile) memory is directly connected to the CPU.

FIG. 3 schematically represents an embodiment of the present invention in which a system main memory of a host system comprises a volatile memory subsystem and a nonvolatile memory subsystem that are addressed through separate memory channels and memory controllers integrated onto a CPU.

FIG. 4 schematically represents another embodiment of the invention in which a system main memory of a host system comprises a volatile memory subsystem and a nonvolatile memory subsystem, the latter of which is an extension of the volatile memory subsystem and is addressed through the same memory channels and memory controller integrated onto a CPU.

FIG. 5 schematically represents a nonvolatile memory module that is pin-compatible with DRAM memory modules and uses a register for translation of control signals to accommodate nonvolatile memory components on the nonvolatile memory module.

FIG. 6 represents a schematic layout of a computer motherboard capable of implementing embodiments of the present invention.

### DETAILED DESCRIPTION OF THE INVENTION

The current invention makes use of nonvolatile memory devices with low access latencies as an extension of a system main memory that uses volatile memory devices, for example, DRAM, more preferably SDRAM and more particularly DDR-SDRAM (DDR), as storage media.

In the current 32-bit operating system environment, the addressable main memory space is limited to 4 GB of volatile memory, which is easily saturated by commodity DDR-SDRAM. With the ongoing transition to the 64-bit operating system environment with an addressable memory space of 16 exabytes (16 EB), extending the memory space beyond the physical DRAM memory array is possible. From a cost perspective, the DRAM memory array can represent approximately about 10 to about 20% of the total acquisition cost of a computer system, as long as total system memory density does not exceed single digit gigabyte values. Extending the DRAM memory array beyond this space adds significant cost to the system.

As a volatile memory technology, every memory cell of a DRAM device must be refreshed approximately every sixty-four milliseconds. Every refresh cycle entails reading the contents of the memory cell into a sense amplifier, where the charges released from the capacitor constituting the cell are amplified during the RAS (row address strobe) pulse and written back to the cell of origin. During the refresh, no other operations can be carried out on the particular bank executing the refresh. With increasing memory density and system main memory capacity, the refresh becomes an important part of the overall functions of the system main memory functionality. That is, the higher the system main memory density, the greater will the overhead be during which all other memory operations need to be suspended. In addition to the performance hit incurred through the necessary refresh cycles, refresh is also very power consuming since the memory array must execute a read followed by a write. It should be evident that with increasing system main memory densities, the power envelope also increases as more rows need to be refreshed.

According to preferred aspects of the present invention, the above-mentioned drawbacks of DRAM can be ameliorated by the use of nonvolatile memory devices, which are typically available at a much lower cost per byte than volatile memory devices, do not incur any performance hit from refresh cycles, and do not consume power for maintenance of their data. The present invention makes advantageous use of these characteristics with a system main memory that contains nonvolatile memory devices to preferably achieve fast accesses and large memory capacities. For example, the nonvolatile memory devices can effectively define a nonvolatile memory subsystem that can be incorporated into a main memory of a host system that also contains a volatile memory subsystem comprising conventional volatile memory devices. Both the volatile and nonvolatile memory subsystems are connected to a CPU of the host system through one or more memory controllers integrated onto the CPU (as used herein, integration of the memory controller onto the CPU encompasses integration onto the same die or within a co-processor on the same processor package). This direct memory mapped access of the nonvolatile memory devices has the advantage of executing, for example, all necessary ECC (error checking and correction) calculations directly on the CPU and at the CPU clock speed without the need of a dedicated (and typically much slower) controller or the use of the system interconnect backbone to transfer all data to the CPU and then back to the nonvolatile memory devices.

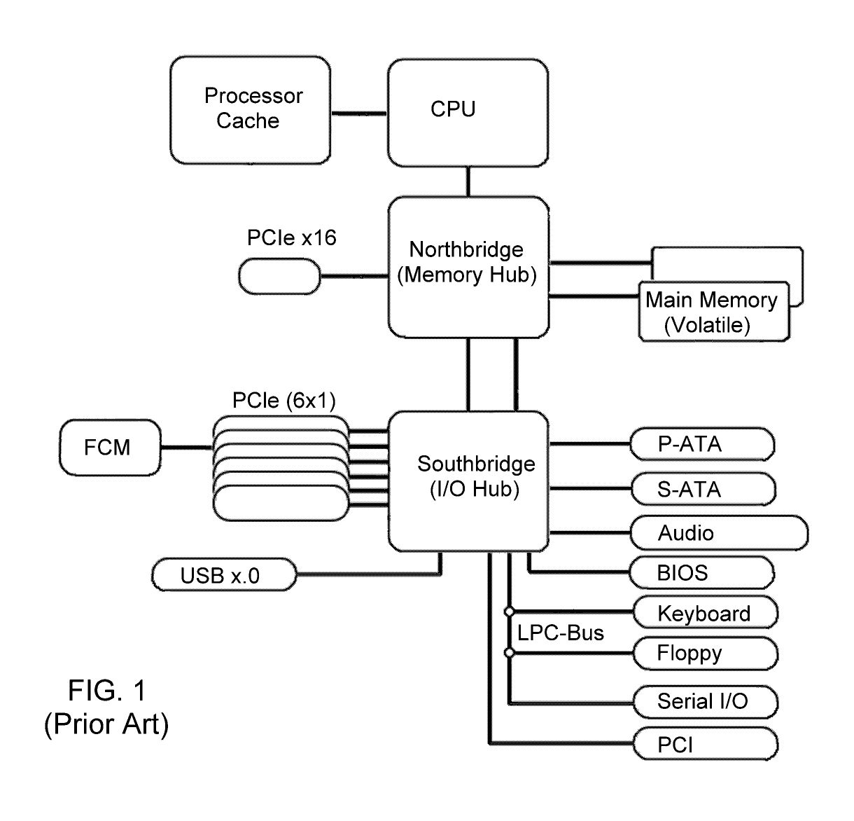

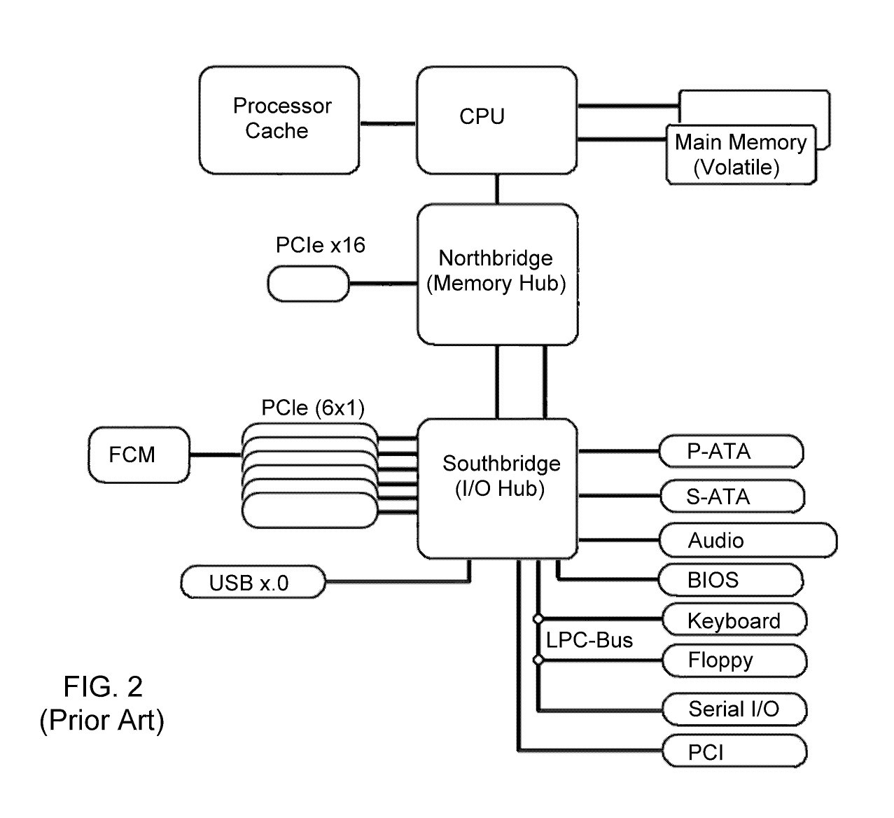

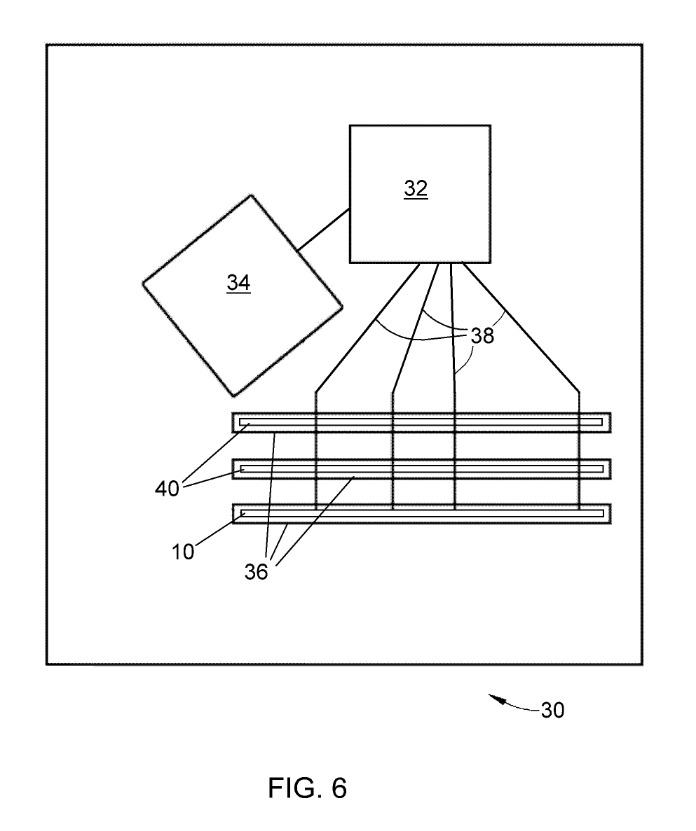

For the purpose of discussing embodiments of the present invention, reference will be made to FIG. 6, which shows a schematic layout of a computer motherboard (mainboard) 30. The motherboard 30 can be of any suitable type of circuit board for use in a host system (not shown), such as a computer and other processing apparatus. The motherboard 30 is shown as including a CPU 32 connected to memory (expansion) slots (sockets) 36 with parallel command address and data buses 38, which are preferably 64-bits in width. The buses 38 may include additional data lanes for ECC or parity data (values). Memory modules 10 and 40 are represented as being installed in the memory slots 36. FIG. 6 also represents a system logic (chip) 34, sometimes referred to as the chipset. In accordance with current conventional practice, the system logic 34 comprises interconnect hubs. One of the hubs is designated as a memory hub (which corresponds at least in part to the northbridge of FIGS. 1 and 2), and another is designated as an I/O (input/output) hub (which corresponds at least in part to the southbridge of FIGS. 1 and 2) for peripheral devices. The system logic 34 can be functionally equivalent to the chipset represented in FIG. 2, and therefore will not be discussed in any detail here. Nonetheless, it is worth noting that the system main memory (represented as comprising the modules 10 and 40 in FIG. 6) is not connected to the system logic 34, but instead is directly connected to the CPU 32 as a result of one or more memory controllers being integrated onto the CPU 32. Other devices of the host system can be conventionally connected to the I/O hub of the system logic 34, similar to what is shown in FIG. 2. For example, the I/O hub of the system logic 34 can be used to control nonvolatile memory-based mass storage devices, such as hard disk drives and solid state drives that utilize P-ATA and S-ATA. As a matter of convenience, other components commonly associated with computer motherboards are not shown in FIG. 6.

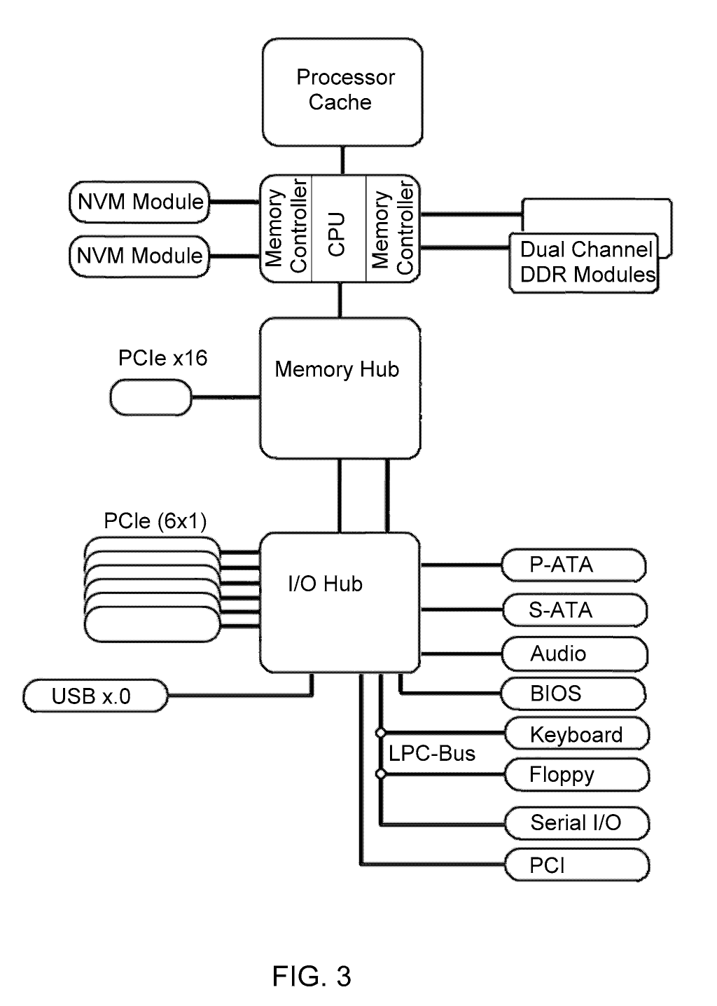

A first embodiment of the invention uses two separate types of memory controllers and separate channels through which volatile memory devices and nonvolatile memory devices can be implemented on, for example, the motherboard 30 of FIG. 6 and addressed by the CPU 32. As represented in FIG. 3, this approach can utilize a volatile memory subsystem made up of volatile memory modules (represented by the modules 40 in FIG. 6) adapted to be received in certain memory slots 36 on the motherboard 30. The volatile memory modules 40 are represented in FIG. 3 as comprising DDR components, which can be mounted on a circuit board as is generally conventional in the art. The memory slots 36 in which the modules 40 are installed can be dedicated slots, for example, dual in-line memory modules (DIMM's), typical for any generation of SDRAM, for example, DDR2, DDR3, or any future generation. The DDR components on the volatile memory modules 40 are represented in FIG. 3 as being addressed by the CPU 32 through dual channels and a memory controller integrated onto the CPU 32.

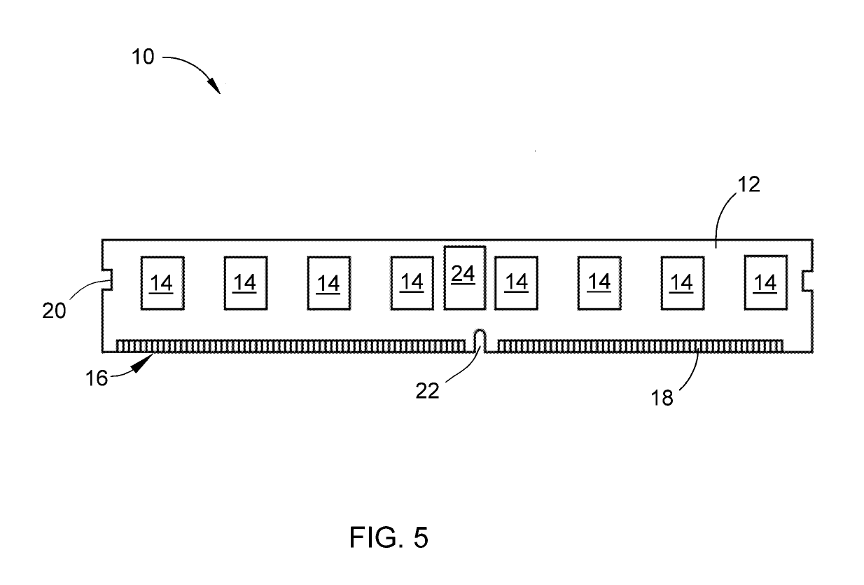

The approach represented in FIG. 3 further utilizes a nonvolatile (permanent) memory (NVM) subsystem is made up of nonvolatile memory components mounted on one or more circuit boards, each yielding a nonvolatile-based memory module. One such module 10 is represented in FIG. 5 and shown installed in one of the memory slots 36 on the motherboard 30 in FIG. 6, though it should be understood that the motherboard 30 could be adapted to accommodate more than one module 10. The nonvolatile memory components can be of various types, including but not limited to NAND or NOR flash technology, ferromagnetic RAM (FRAM), magnetic RAM (MRAM), resistive RAM (RRAM), phase change memory (PCM), or any other emerging form of nonvolatile memory. As will be discussed in reference to FIG. 5, the nonvolatile memory (NVM) module 10 can use a physically different type of interface to prevent its accidental insertion into one of the other slots 36 intended for a volatile memory module 40. The nonvolatile memory components on the NVM module 10 are represented in FIG. 3 as being addressed by the CPU 32 through a memory controller that is also integrated onto the CPU 32, but separate from the memory controller for the volatile memory modules 40. As noted above, all necessary ECC calculations for the nonvolatile memory components on the NVM module 10 can be executed directly on the CPU 32 without the need of a dedicated off-chip controller or the use of the system interconnect backbone to transfer all data to the CPU 32 and then back to the nonvolatile memory components of the module 10.

The volatile memory subsystem, which will typically have a speed advantage over the nonvolatile memory subsystem, can be used in the same fashion as is conventional for existing host systems, namely, as an extension of the CPU's cache memory (integrated processor cache) for all data that fit into the memory space. The volatile memory space available on a host system is determined by reading the serial presence detect (SPD) on each volatile memory module 40 present in the system to allow for flexible configuration of the DDR components with maximum efficiency of use. In other words, if 4 GBytes of DRAM memory are present, the host system will use those 4 GB first before using any additional tier of memory. In most cases, certain amounts of memory space will further be hard allocated to the DDR components. For example, memory required to shadow the system's hardware, such as graphics cards or PCIe subsystem, will typically be taken from the DRAM space because of latency and bandwidth requirements.

In general, the relation between the volatile and the nonvolatile memory space of the invention may be viewed as very similar to that of the processor cache and the system memory of current computer systems. If the workload exceeds the memory space made available by the one or more volatile memory modules 40, the main memory of the host system allows the workload to flow over into the memory space made available by the one or more NVM modules 10, similar as in the case of a page file on conventional hard disk drives. Moreover, since the nonvolatile memory space retains data regardless of whether the system is powered, it can be used to store the operating system and/or applications if so desired by the user/operator. Another way to describe the relationship between the volatile and nonvolatile memory subsystems is that both together define a combined direct memory-mapped physical system main memory space. The volatile memory becomes a large extension of the processor cache using the known technology of virtual addressing, and the NVM modules 10 further extend the spatial and temporal locality of the volatile memory space using secondary virtual addressing.

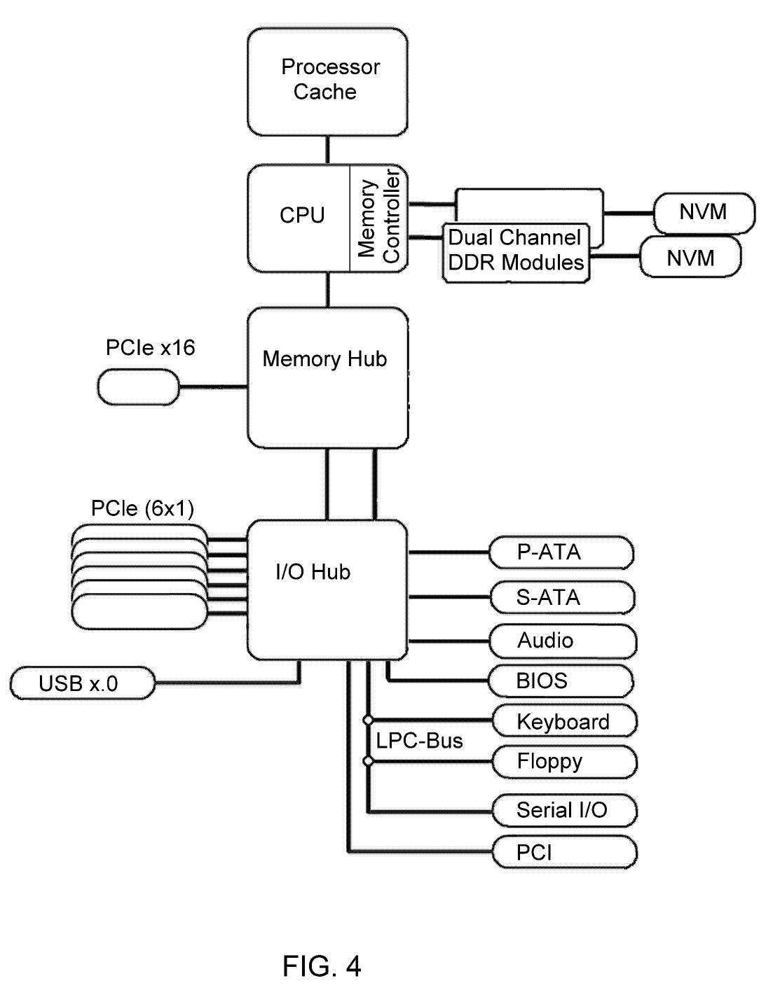

In a second embodiment represented in FIG. 4, modules 10 and 40 of the nonvolatile and volatile memory subsystems, respectively, can be configured to use the same type of slot interface. This approach enables the system to be configured in a flexible way by populating each memory slot 36 with either type of memory (nonvolatile or volatile memory modules 10 or 40). The nonvolatile and volatile memory components of the nonvolatile and volatile memory modules 10 and 40 are represented in FIG. 4 as being addressed by the CPU 32 through a single memory controller integrated onto the CPU 32. As previously noted regarding the embodiment of FIG. 3, if ECC or parity is required, all necessary calculations for the nonvolatile memory components on the NVM module 10 can be executed directly on the CPU 32 without the need of a dedicated off-chip controller or the use of the system interconnect backbone to transfer all data to the CPU 32 and then back to the nonvolatile memory components.

The individual mode of operation for the different technologies can be recognized by a single memory controller by reading the SPD on the memory modules 10 and 40. In this case, the chip-select signal can be tied to the respective state machine of the memory controller, that is, as soon as one of the modules 10 or 40 is selected for a read or write operation, the internal configuration of the controller will change accordingly to adjust to the different timing and drive-strength requirements. As known in the art, each SPD can be embodied in a ROM (read-only memory) chip, for example, an EEPROM (electrically-erasable programmable read-only memory) chip, which can be interfaced with the motherboard 30 over a dedicated serial bus (not shown) rather than the parallel command address and data buses 38 used for interfacing between the memory devices on the memory modules 10 and 40 and their shared memory controller on the CPU 32. The SPDs can also contain the functional datasheet of their respective memory modules 10 and 40, that is, data corresponding to various physical and operational characteristics of the module 10 or 40, including the number of banks, rows, and columns, and performance parameters such as operating frequency and access latencies. As such, the SPDs of the modules 10 and 40 play an important role in implementing a plug-and-play capability for a system main memory adapted to contain the nonvolatile and volatile memory modules 10 and 40, which in turn are adapted to be inserted into any open memory slot 36.

FIG. 5 represents an NVM module 10 as comprising a substrate 12 on which is mounted a number of nonvolatile memory components 14. In practice, the substrate 12 is typically in the form of a printed circuit board (PCB), though other types of substrates are also within the scope of this invention. To provide the electrical connection between the module 10 and one of the memory slots 36 in FIG. 6, the module 10 includes an edge connector 16 along one edge of the substrate 12, by which digital signals (command, address, and data) are transmitted to and from the components 14 through input/output (I/O) pins 18. If the module 10 is to be implemented as represented in FIG. 3, the pins 18, retention notches 20 and/or a key 22 can be configured to provide the NVM module 10 with an interface whose physical configuration (form factor) prevents accidental insertion of the module 10 into one of the slots 36 intended for a volatile memory module 40. Alternatively, if intended to be implemented as represented in FIG. 4, the pins 18, retention notches 20 and key 22 can be configured to allow the NVM module 10 to be interchangeably inserted into a slot 36 that also accepts a volatile memory module 40.

If the implementation of FIG. 4 is utilized, the transition between the different types of modules 10 and 40 can be facilitated through the use of a buffer or register on the NVM module 10 and/or on the volatile memory modules 40. For example, FIG. 5 shows the NVM module 10 containing an ASIC (application-specific integrated circuit) chip 24 as a bridge chip for translating DRAM control signals into the correct control signals for the NVM components 14 on the module 10. In addition, there may be a write cache (not shown) on the module 10 that can be integrated onto the ASIC chip 24 or a different IC chip on the module 10.

The implementation represented in FIG. 4 has the advantage of allowing the system integrator complete flexibility with respect to the configuration of the system depending on the specific requirements and demands on the workload. Since all memory slots 36 can be the same and populated with either type of memory module 10 and 40, the use of real estate on the motherboard 30 is more economically used than in the embodiment of FIG. 3, in which different interfaces are required for the NVM and volatile memory modules 10 and 40.

With the implementations represented by FIGS. 3 and 4, it is possible to provide a system main memory in which a volatile memory subsystem comprising the volatile memory modules 40 is used as a cache for a nonvolatile memory subsystem and its NVM modules 10. In such an embodiment, data compression can be executed in the memory space of the volatile memory subsystem before storing the data in the memory space of the nonvolatile memory subsystem. It is also foreseeable that the system main memory could be comprised exclusively of one or more NVM modules 10, in other words, volatile memory modules 40 are not installed in any of the memory slots 36.

While the invention has been described in terms of specific embodiments, it is apparent that other forms could be adopted by one skilled in the art. Therefore, the scope of the invention is to be limited only by the following claims.

1. A host system having a central processing unit, processor cache, and a system main memory, the system main memory comprising:
first and second memory slots;
a volatile memory subsystem comprising at least one DRAM-based memory module received in the first memory slot and addressed by the central processing unit;
a nonvolatile memory subsystem comprising at least a first nonvolatile-based memory module in the second memory slot and addressed by the central processing unit; and
at least one memory controller integrated onto the central processing unit for controlling the processor cache, the volatile memory subsystem, and the nonvolatile memory subsystem.

2. The host system of claim 1, wherein the at least one memory controller comprises at least first and second memory controllers integrated onto the central processing unit, the nonvolatile memory subsystem is controlled by the first memory controller, the volatile memory subsystem is controlled by the second memory controller that is separate from the first memory controller, and the DRAM-based memory module and the first nonvolatile-based memory module are connected to the central processing unit via different channels.

3. The host system of claim 1, wherein the at least one memory controller comprises a first memory controller integrated onto the central processing unit, the nonvolatile and volatile memory subsystems are controlled by the first memory controller, and the DRAM-based memory module and the first nonvolatile-based memory module are connected to the central processing unit via the same channel.

4. The host system of claim 3, further comprising a read-only memory chip on each of the DRAM-based and first nonvolatile-based memory modules, each read-only memory chip having a serial presence detect function that is readable by the first memory controller to enable a mode of operation for interfacing with each of the DRAM-based and first nonvolatile-based memory modules.

5. The host system of claim 4, wherein a chip-select signal associated with the first memory controller enables different state machines when accessing either of the DRAM-based and first nonvolatile-based memory modules so as to adapt the first memory controller for different timing and drive-strength requirements of the DRAM-based and first nonvolatile-based memory modules.

6. The host system of claim 1, further comprising an ASIC chip integrated on the first nonvolatile-based memory module and adapted to translate DRAM control signals into nonvolatile memory control signals.

7. The host system of claim 1, wherein the volatile and nonvolatile memory subsystems together define a combined direct memory-mapped physical system main memory space of the host system.

8. The host system of claim 1, further comprising a motherboard on which the first and second memory slots are mounted.

9. The host system of claim 1, further comprising a system logic having an input/output hub, and at least one nonvolatile memory-based mass storage device addressed through the input/output hub.

10. The host system of claim 1, wherein the first nonvolatile-based memory module comprises a nonvolatile memory component chosen from the group consisting of NAND flash, NOR flash, ferromagnetic RAM (FRAM), magnetic RAM (MRAM), resistive RAM, and phase change memory devices.

11. A method for expanding a system memory space of a host system that comprises a motherboard, a central processing unit having an integrated processor cache, a system logic, a nonvolatile memory-based mass storage device controlled by the system logic, and at least two memory slots, the method comprising:
installing a DRAM-based volatile memory module and a first nonvolatile-based memory module in the memory slots;
directly controlling the DRAM-based volatile memory module and the first nonvolatile-based memory module with at least one memory controller integrated on the central processing unit; and
using parallel command address and data buses as an interface between the first nonvolatile-based memory module and the central processing unit.

12. The method of claim 11, wherein the data bus is 64-bits wide and comprises additional data lanes for error checking and correction values for nonvolatile memory components on the first nonvolatile-based memory module.

13. The method of claim 11, the method further comprising switching the at least one memory controller between different modes of operation relative to a first of the memory slots depending on whether the DRAM-based volatile memory module or the first nonvolatile-based memory module is installed in the first memory slot.

14. The method of claim 13, the method further comprising:
using the at least one memory controller to read a read-only memory chip on each of the DRAM-based and first nonvolatile-based memory modules, each read-only memory chip having a serial presence detect function that is read by the at least one memory controller and used to enable the mode of operation for interfacing with the DRAM-based or first nonvolatile-based memory module in the first memory slot; and
mapping information about the DRAM-based or first nonvolatile-based memory module in the first memory slot to a chip-select signal.

15. The method of claim 14, further comprising selecting the DRAM-based or first nonvolatile-based memory module in the first memory slot using the chip-select signal, wherein the selecting step automatically changes the state machine of the at least one memory controller to the mode of operation appropriate for the DRAM-based or first nonvolatile-based memory module in the first memory slot.

16. The method of claim 15, wherein the DRAM-based volatile memory module serves as a cache for the first nonvolatile-based memory module.

17. The method of claim 16, wherein data is compressed with the DRAM-based volatile memory module before being stored data on the first nonvolatile-based memory module.

18. The method of claim 11, wherein the first nonvolatile-based memory module comprises a nonvolatile memory component chosen from the group consisting of NAND flash, NOR flash, ferromagnetic RAM (FRAM), magnetic RAM (MRAM), resistive RAM, and phase change memory devices.

19. A method for creating a high-capacity system main memory in a host system, wherein a central processing unit comprises an integrated cache and an integrated memory controller that accesses the system main memory, the method comprising installing a nonvolatile-based memory device in the system main memory and operating the integrated memory controller to write and read data to and from the nonvolatile-based memory device.

20. The method of claim 19, further comprising installing a volatile memory device in the system main memory and writing and reading data to and from the volatile memory device.

21. The method of claim 19, wherein the nonvolatile-based memory device is chosen from the group consisting of NAND flash, NOR flash, ferromagnetic RAM (FRAM), magnetic RAM (MRAM), resistive RAM, and phase change memory devices.
